(19) United States
(12) Patent Application Publication
(10) Pub. No.: US 2004/0201189 A1
(43) Pub. Date: Oct. 14, 2004

(54) Configurable wheelbarrow

(76) Inventor: Matthew R. Morse SR., Portland, OR (US)

Correspondence Address: Matthew R. Morse Sr., 5215 N. Denver Ave, Portland, OR, 97217, US

(21) Appl. No.: 10/412,892

(22) Filed: Apr. 14, 2003

(51) Int. Cl. B62B 1/20

(52) U.S. Cl. 280/47.31

(57) ABSTRACT

A heavy duty configurable wheelbarrow with retractable handles, a bin (sometimes referred to in the prior art as a tray or bucket), with a wheel and legs on a frame that rotates on a hinge at the front of the bin such that the wheel, stand and frame rotate over the front of the bin and recess into the interior of the bin for storage and transportation and separately the handles fully recess into the frame of the bin.

### FIELD OF THE INVENTION

The present invention relates to a configurable or collapsible wheelbarrow for use performing typical yard and construction tasks such as moving soil, leaves, bark and debris, and building supplies such as dirt, gravel, bricks, and tools.

### BACKGROUND OF THE INVENTION

Used extensively in current construction, the wheelbarrow is tried, true, and tested as one of the most useful tools ever invented. The wheelbarrow carries a greater load than an individual can, and more easily. Current bin designs, configurations and load capabilities must be considered to be nearly perfect after thousands of years of use. This invention does not attempt to improve on the load carrying capabilities of the wheelbarrow but rather focuses on a problem of using wheelbarrows in the current modern world.

In current practice in the United States, construction workers work at multiple work sites, and for many days. Because of potential theft and risk of loss of construction tools it is standard practice for workers to transport tools from one site to another, and away from job sites on a daily or regular basis.

Practically speaking, wheelbarrows are moved frequently and transported by truck or car on a regular or even daily basis. A problem arises in that wheelbarrows, while well designed for their intended use, are bulky, cumbersome, and oddly shaped and do not fit well or easily in the back of trucks or cars. The legs, wheel, and handles stick out and result in the wheelbarrow taking up a lot of room in a truck or car trunk, relative to its size.

In addition wheelbarrows are oddly weighted and do not easily lay on their sides or vertically. They are most stable when laid upside down but turning them upside down is awkward and can result in debris falling out of the bin. When transported standing up on its legs and wheels, a wheelbarrow can move about and tip over to the left or right, often requiring that the wheelbarrow be braced, blocked, tied, or wedged against other objects.

It is therefore desirable to have the use of a wheelbarrow when necessary, but be able to easily transport and store the wheelbarrow in the smallest reasonable space and with the least possible chance of it shifting or falling over during transportation.

The present invention overcomes both of the above-mentioned difficulties of space and stability.

### SUMMARY OF THE INVENTION

By means of the present invention, workers can enjoy the benefits and usefulness of the classic wheelbarrow and move and transport their wheelbarrow more easily, in less space, and store it in a smaller space. This usefulness is accomplished by extending the handles and by extending and locking the undercarriage frame when the wheelbarrow is in use, and by recessing the handles and by rotating the undercarriage frame into the interior of the bin when the wheelbarrow is not in use.

### BRIEF DESCRIPTION OF THE DRAWINGS

FIG. 1 is a side view of the present invention showing the bin (1), the handles (2) fully extended, the cylindrical holes (3) for holding the handles when recessed, the undercarriage frame (4), the legs (5) at the back of the frame and at the rear of the wheelbarrow, the wheel (6) transversely mounted on the axle and attached to the frame, the E-shaped channel (7) in the cylindrical handle hole (3), and the hinges of the configurable frame (14).

FIG. 2 is a rear view of the same wheelbarrow as shown in FIG. 1, and additionally the frame hinge (10) at the front of the bin.

FIG. 3 shows the front view of the same wheelbarrow as shown in FIG. 1.

FIG. 4 shows the top view of the same wheelbarrow as shown in FIG. 1.

FIG. 5 shows the bottom view of the same wheelbarrow as shown in FIG. 1.

FIG. 6 shows a close up side view of the right side of the bin (1) showing the cylindrical handle hole (3) with the handle removed, thereby showing the E-shaped formation of the channel on the side of the hole.

FIG. 7 shows, for the purpose of illustration only, (the handles are not designed to be removed) the handle (2) removed from the cylindrical handle hole, thereby showing the stopping pegs (8), and the gripping handle (9).

FIG. 8 shows the undercarriage frame (4), the wheel (6), the legs (5), the mounting/securing mechanism (11) attached to the frame and passing through and securing the frame to the underside of the bin. The bin receptacles are shown shaded (12), through which pass the securing mechanism.

FIG. 9a shows a rear view of the underside of the bin with the raised receptacles (12) for attachment to the frame securing mechanism.

FIG. 9b shows a side view of the underside of the bin with the raised receptacles (12) in line for attachment to the frame securing mechanism.

FIG. 10 shows the underside of the bin with an alternative securing mechanism (13). The hatched segments on two of the four quadrants represent the bin frame as seen through the openings of the securing mechanism.

FIG. 11a shows a rear view of the underside of the bin with the alternative design for the raised receptacles (12) for attachment to the frame securing mechanism.

FIG. 11b shows a side view of the underside of the bin with the same alternative design as FIG. 10a for the raised receptacles (12) in line for attachment to the frame securing mechanism.

FIG. 12 shows the invention completely recessed and ready for storage and/or transport. Note that the hinged frame is totally recessed within the bin and therefore not visible.

### DETAILED DESCRIPTION OF THE PREFERRED EMBODIMENTS

The descriptive terminology used herein is intended to be explanatory of the benefits of the invention and is not intended to be a description of limitation.

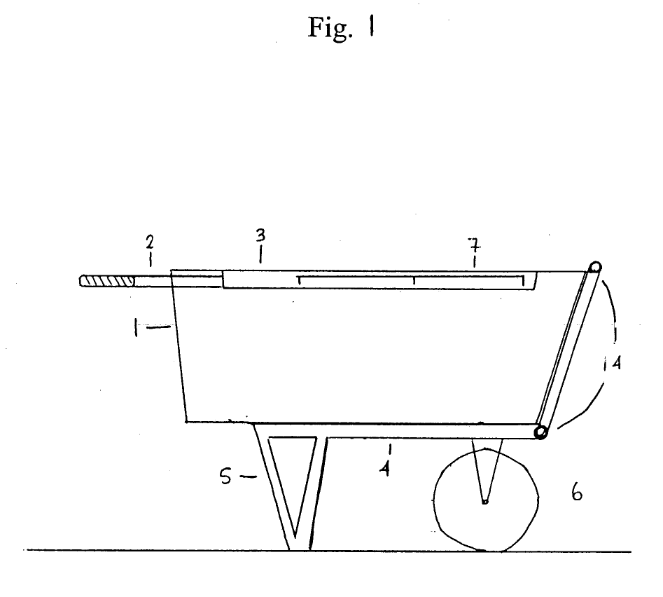

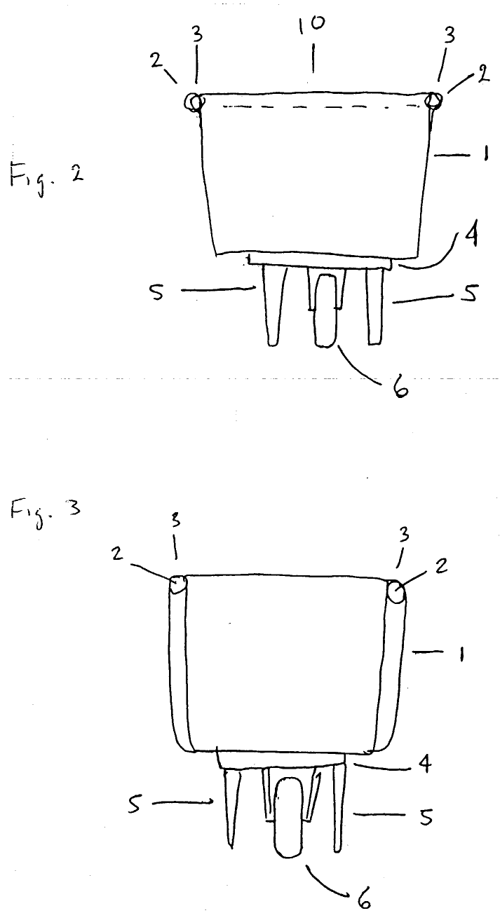

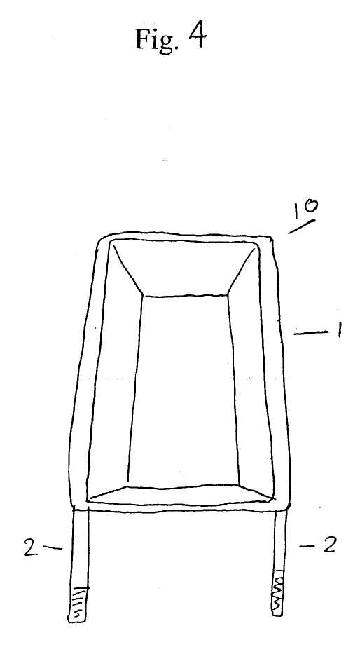

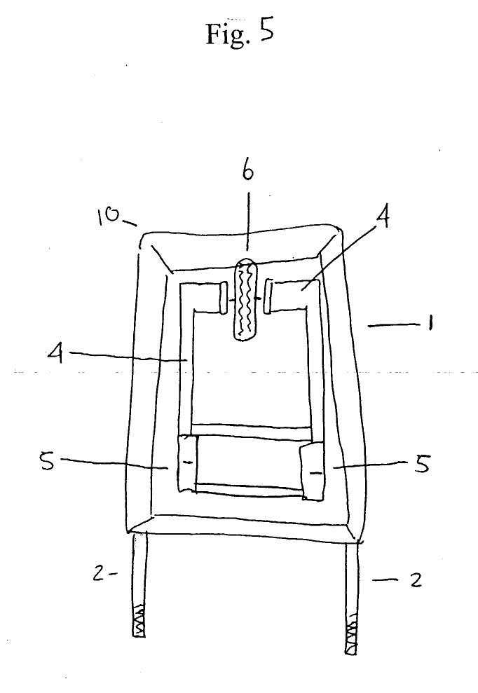

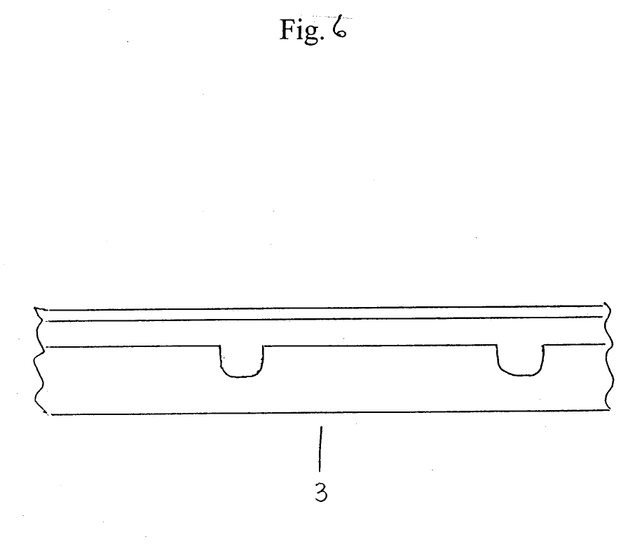

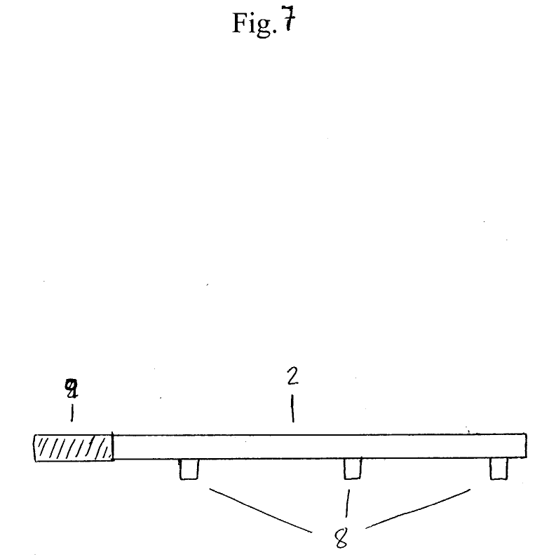

Referring to FIG. 1 of the drawings herein, the invention in its entirety is shown from a side view in the fully assembled and upright position. The undercarriage frame is locked in the assembled position and the handles are locked in the fully extended position.

The present invention has two primary dynamic elements. The first is the handle configuration. The second is the frame assembly and movement for use and for storage.

The handle configuration with the sliding handles in the cylindrical hole is designed to allow the handle to slide and then lock into one of three distinct positions. The positions are fully extended, partially extended, and fully recessed. When the handles are fully extended (and the frame is fully assembled and locked), the wheelbarrow looks and operates like other wheelbarrows: the user stands behind the wheelbarrow, lifts both handles and moves the wheelbarrow. When the handles are partially extended, the user must stand closer to the wheelbarrow to grip the handles. Other than that the user operates the wheelbarrow in the same manner as other wheelbarrows. When the handles are fully recessed, the wheelbarrow is intended to be stored and/or transported and the handles are recessed in order to save space.

The frame assembly has two positions. The first position is when the rigid frame, including legs, and wheel, is recessed in the interior of the bin. This position is for transporting and storing the wheelbarrow in the smallest reasonable space, and it is expected that this frame position, although mechanically independent from the handle positions, would correspond to the handles also being recessed.

The second frame position is when the rigid frame, including legs, and wheel, is correctly attached to the underside of the bin. This is accomplished by carefully rotating the hinged frame out of the bin, rotating the entire frame over the front of the wheelbarrow, completely around and then under the bin. The frame is then placed flat on the underside of the bin and the locking mechanism is engaged, thereby securing the frame to the bin.

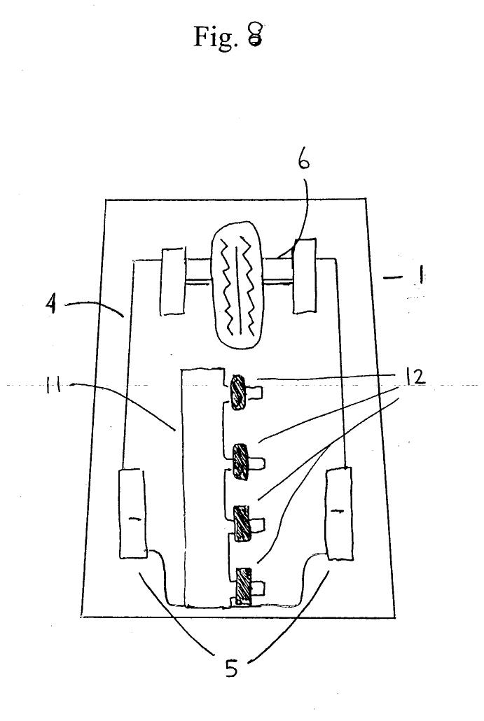

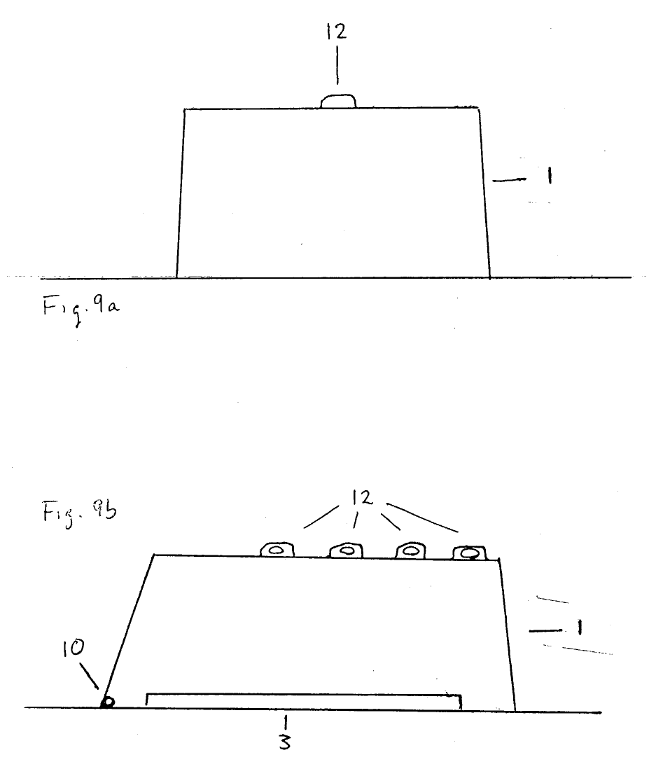

The locking mechanism shown in FIG. 8 and FIGS. 9a and 9b slides laterally from left to right when the bin is upside down. Sliding the mechanism firmly from left to right into the bin receptacles secures the bin to the frame. Sliding the mechanism from right to left releases the frame from the bin.

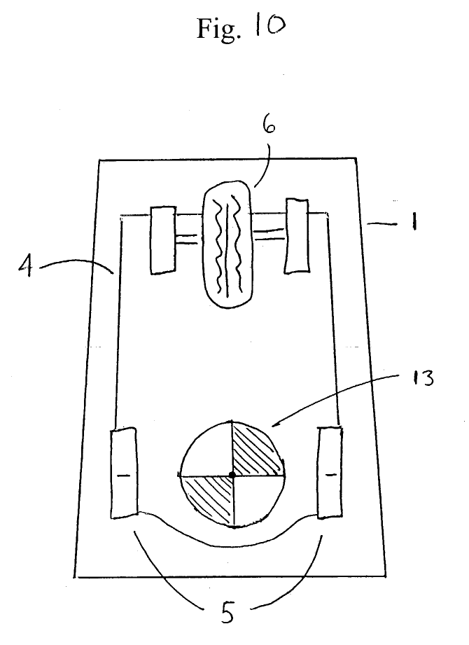

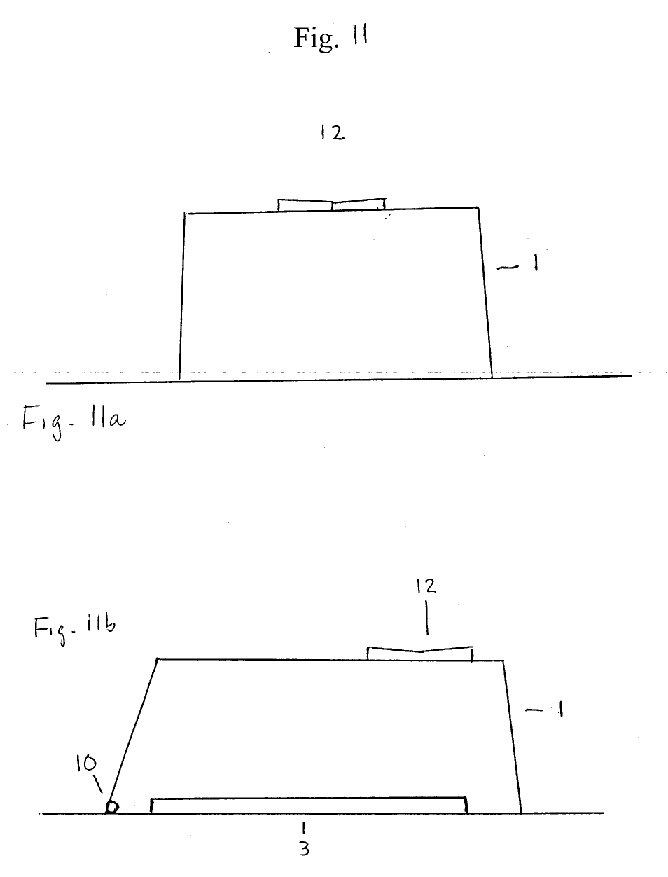

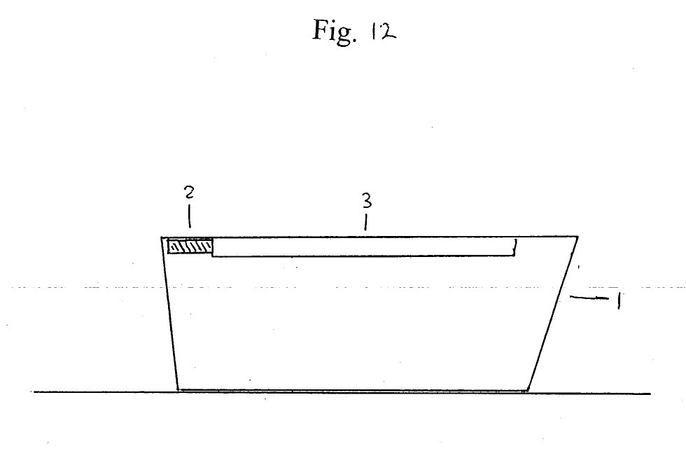

In the locked position the frame is securely and correctly attached to the underside of the bin, and the handles are fully or partially extended and locked. The wheelbarrow is fully operational and is used like any other wheelbarrow. In the alternative design shown in FIG. 10 and FIGS. 11a and 11b, the securing mechanism is a circular disk with two offset fans set at an 11-degree angle such that the frame is placed on the underside of the bin and then the securing device is rotated 90 degrees into the bin receptacle. The bin receptacle interior is designed in proportion and size to the exterior portion of the frame mechanism such that the device is designed to tighten as the mechanism rotates toward a 90-degree turn and fully engages the bin receptacle. Disassembly is easily achieved by rotating the mechanism 90 degrees in the opposite direction.

The hinged frame portion of the invention is never intended to be positioned in any other position other than fully secured under the frame or fully recessed in the bin.

FIG. 9 shows the invention fully recessed and ready for storage and/or transport. Although multiple aspects and uses of the invention have been described pictorially and in written form, it should be noted that other modifications and additions may be made thereto and without departing from the scope thereof.

Having described my invention and the manner in which it may be used, I claim:

1. A configurable wheelbarrow that is adjustable between erected and folded positions comprising a bin, a hinged frame with a wheel and legs, and collapsible handles; wherein a pair of handles extend in multiple set positions ranging from fully extended, to partially extended, and to fully recessed in the frame of the bin, and a rigid frame comprised of cross bracing, a wheel mounted for rotation on an axle transversely mounted on the frame under the bin and toward the front of the wheelbarrow, and legs rigidly fixed on the frame toward the back of the frame, thereby creating, with the wheel, a three-point stand.

2. A configurable wheelbarrow as in claim 1, wherein the entire wheelbarrow bin, frame, and handles are symmetrical along the longitudinal axis.

3. A configurable wheelbarrow as in claim 1, wherein the bin shell is formed of one piece of durable material, such as metal or plastic.

4. A configurable wheelbarrow as in claim 3, wherein said bin is rigid in all parts and composition.

5. A configurable wheelbarrow as in claim 1, wherein said bin has two horizontal holes running the length of the wheelbarrow from front to back, on the left side and on the right side of the bin.

6. A configurable wheelbarrow as in claim 5, wherein said holes are positioned on the outside of the bin.

7. A configurable wheelbarrow as in claim 5, wherein said holes are part of the original construction of the one-piece bin.

8. A configurable wheelbarrow as in claim 5, wherein said holes have a single channel running a portion of the length of the cylinder.

9. A configurable wheelbarrow as in claim 8, wherein said channels have branches off of the main channel, thereby creating an E-shaped configuration.

10. A configurable wheelbarrow as in claim 5, wherein said holes contain cylindrical handles.

11. A configurable wheelbarrow as in claim 10, wherein said handles slide in and out of the bin holes.

12. A configurable wheelbarrow as in claim 10, wherein said handles have grips or a grippable surface at the rear end of each handle.

13. A configurable wheelbarrow as in claim 10, wherein said handles have stopping pegs at right angles to the length of the handle.

14. A configurable wheelbarrow as in claim 13, wherein said pegs protrude through a channel running a portion of the length of the hole.

15. A configurable wheelbarrow as in claim 1, wherein said wheelbarrow contains a rigid frame connected to the front of the bin by a transversely mounted hinge.

16. A configurable wheelbarrow as in claim 15, wherein said frame, cross supports, and legs are constructed of a durable and rigid material such as metal or plastic.

17. A configurable wheelbarrow as in claim 16, wherein said frame is additionally hinged at the juncture of the generally vertical portion of the frame and of the horizontal portion of the frame.

18. A configurable wheelbarrow as in claim 15, wherein said frame is comprised of two legs, cross supports and a transversely mounted axle for a wheel.

19. A configurable wheelbarrow as in claim 18, wherein said legs are rigidly mounted vertically to the frame.

20. A configurable wheelbarrow as in claim 18, wherein said legs are equal and identical in all respects to each other.

21. A configurable wheelbarrow as in claim 15, wherein said frame attaches to the underside of the bin by means of a locking mechanism.

22. A configurable wheelbarrow as in claim 15, wherein said locking mechanism is a smooth and seamless interlocking interaction of the frame and the underside of the bin.

23. A configurable wheelbarrow as in claim 15, wherein said locking mechanism is comprised of an E-shaped slidable locking bar.

24. A configurable wheelbarrow as in claim 15, wherein said slidable locking bar is attached to the undercarriage frame.

25. A configurable wheelbarrow as in claim 15, wherein said E-shaped slidable locking bar penetrates the underside of the bin at multiple points and secures the frame to the bin by insertion and tension upon the bin.
